(19) United States
(12) Patent Application Publication
(10) Pub. No.: US 2025/0383833 A1
(43) Pub. Date: Dec. 18, 2025

(54) AUDIO REPRODUCTION DEVICE, AUDIO REPRODUCTION METHOD, AND AUDIO REPRODUCTION PROGRAM

(71) Applicants: Sony Group Corporation, Tokyo (JP); Sony Interactive Entertainment Inc., Tokyo (JP)

(72) Inventors: Takuto Onishi, Tokyo (JP); Masahiko Koizumi, Tokyo (JP); Chihiro Sugai, Tokyo (JP); Taiki Endo, Tokyo (JP); Keiichi Kitahara, Tokyo (JP); Satsuki Sato, Tokyo (JP)

(73) Assignees: Sony Group Corporation, Tokyo (JP); Sony Interactive Entertainment Inc., Tokyo (JP)

(21) Appl. No.: 18/877,464

(22) PCT Filed: Jun. 14, 2023
(86) PCT No.: PCT/JP2023/022046

§ 371 Date: Dec. 20, 2024

(30) Foreign Application Priority Data
Jun. 29, 2022 (JP) 2022-104879

(51) Int. Cl. G06F 3/16; H04S 7/00

(52) U.S. Cl. CPC G06F 3/165; H04S 7/30

(57) ABSTRACT

An audio reproduction device (100) according to the present disclosure includes a reception unit (132) that receives, from a user, a request for reproducing a second audio signal that is an audio signal different from a first audio signal that is an original audio signal of content, and a reproduction unit (133) that localizes the second audio signal at an arbitrary position in an acoustic space including an azimuth direction and a height direction and outputs the first audio signal and the second audio signal in parallel when the reception unit receives the request.

### FIELD

The present disclosure relates to an audio reproduction device, an audio reproduction method, and an audio reproduction program. Specifically, the present disclosure relates to localization processing of reproduction audio in a spatial acoustic content.

### BACKGROUND

Due to technical background such as development of encoding technology of audio data and video data, capacity increase and size reduction of a storage device, and diversification of acquisition routes using a network, there are increasing opportunities for users to use a video content and a music content.

Under such circumstances, in order to improve the convenience of the user, a technology of simultaneously reproduction a plurality of contents has been proposed as a technology of quickly searching for a target content from a large amount of music content owned by the user (for example, Patent Literature 1). Furthermore, in a case where a plurality of audio sources included in one content is mixed, a technology for assisting a user to identify a plurality of audio sources by changing a user's perception position using signal processing has been proposed (for example, Patent Literature 2).

### CITATION LIST

### Patent Literature

Patent Literature 1: JP 2008-226400 A

Patent Literature 2: JP 2011-505106 W

### SUMMARY

### Technical Problem

According to the prior art, it is possible to quickly search for target content from a large amount of music content and to experience various reproduction environments in audio content including a plurality of audio sources. However, there is still room for further improvement in a technique of increasing the use of content and improving the convenience.

Therefore, the present disclosure proposes an audio reproduction device, an audio reproduction method, and an audio reproduction program capable of improving the convenience of content.

### Solution to Problem

An audio reproduction device according to one embodiment of the present disclosure includes a reception unit that receives, from a user, a request for reproducing a second audio signal that is an audio signal different from a first audio signal that is an original audio signal of content, and a reproduction unit that localizes the second audio signal at an arbitrary position in an acoustic space including an azimuth direction and a height direction and outputs the first audio signal and the second audio signal in parallel when the reception unit receives the request.

### BRIEF DESCRIPTION OF DRAWINGS

FIG. 1 is a diagram (1) illustrating an outline of audio reproduction processing according to an embodiment.

FIG. 2 is a diagram (2) illustrating an outline of audio reproduction processing according to the embodiment.

FIG. 3 is a flowchart illustrating an example of localization processing of a sub-audio according to the embodiment.

FIG. 4 is a diagram illustrating a configuration example of an audio reproduction device according to the embodiment.

FIG. 5 is a diagram illustrating an example of a content storage unit according to the embodiment.

FIG. 6 is a diagram illustrating an example of a definition information storage unit according to the embodiment.

FIG. 7 is a flowchart illustrating a procedure of audio reproduction processing according to the embodiment.

FIG. 8 is a hardware configuration diagram illustrating an example of a computer that implements functions of THE AUDIO REPRODUCTION DEVICE.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

The present disclosure will be described according to the following order of items.
1. Embodiment
1-1. Outline of Audio Reproduction Processing According to Embodiment
1-2. Configuration of Audio Reproduction Device According to Embodiment
1-3. Procedure of Audio Reproduction Processing According to Embodiment
1-4. Modification According to Embodiment
1-4-1. Application Example of Audio Reproduction Processing
1-4-2. Content Format Type
1-4-3. Mode of Sub-Audio
2. Other Embodiments
3. Effects of Audio Reproduction Device According to
Present Disclosure
4. Hardware Configuration

### 1. Embodiment

### 1-1. Outline of Audio Reproduction Processing According to Embodiment

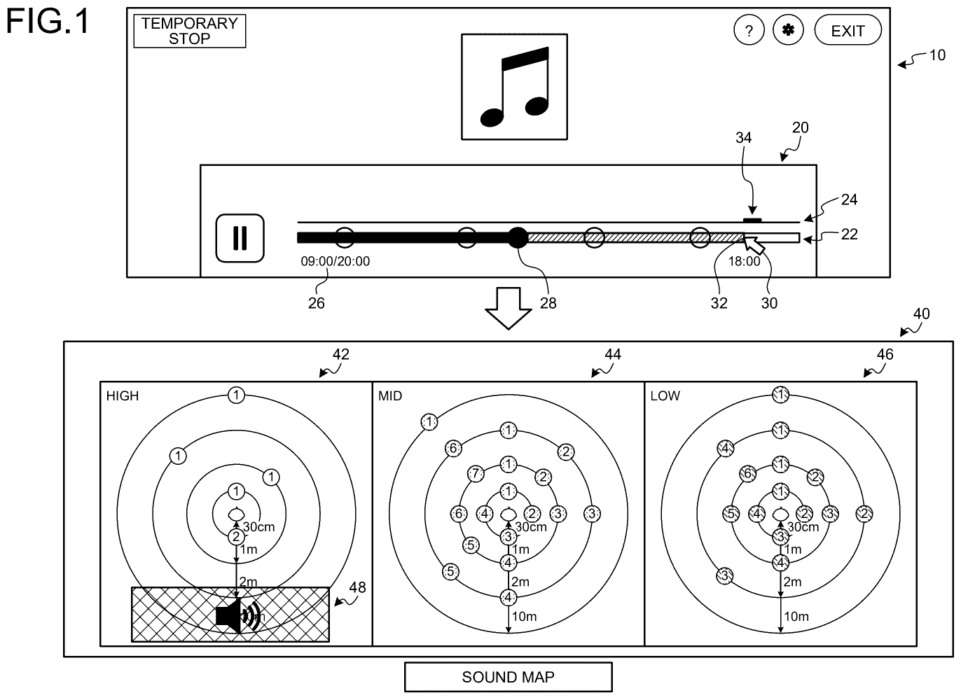

First, an outline of audio reproduction processing according to an embodiment will be described with reference to FIG. 1. FIG. 1 is a diagram (1) illustrating an outline of audio reproduction processing according to the embodiment.

The audio reproduction processing according to the embodiment is executed by an audio reproduction device 100 (not illustrated in FIG. 1). The audio reproduction device 100 is, for example, an information processing terminal such as a personal computer (PC), a smartphone, or a tablet device. The audio reproduction device 100 provides the audio subjected to the audio reproduction processing according to the embodiment to a listener (hereinafter, referred to as a “user”). Note that the audio reproduction device 100 may output audio from its own device, or may output audio to a reproduction device (headphones, earphones, loudspeakers, and the like) used by the user to listen to an audio signal via wired or wireless communication.

The audio reproduction processing according to the present disclosure is applied to a case where an audio signal (hereinafter, referred to as “sub-audio”) different from a main audio signal (hereinafter, simply referred to as “main audio”) which is an original audio signal of content is reproduced in media content (hereinafter, referred to as “content”) such as music, video, and a network distribution moving image, a case where another audio is reproduced during reproduction of the main audio, and the like. Note that the sub-audio according to the present disclosure includes various modes such as an audio completely different from the main audio such as a bonus track due to explanation regarding the content or a performer comment, and an audio that is the same as the main audio but has a different reproduction timing (past or future audio with respect to the current reproduction position of the content).

In general, since confusion occurs in audio reproduction, it is difficult for the user to simultaneously listen to the main audio and the sub-audio. In this regard, regarding the video, it is possible to simultaneously display completely different videos in parallel by arranging a plurality of screens on the user interface. Moreover, it is also possible to simultaneously display videos having different reproduction timings in one content. Specifically, in a case where the user performs a search using a seek bar for searching for a point to be reproduced in the video, the reproduction device displays a small video as a thumbnail on the seek bar while displaying the video corresponding to the current reproduction position of the content, so that the video of the location searched by the user can be simultaneously displayed. However, in the case of an audio, when the main audio and the sub-audio are reproduced at the same time, both the audios are confused, and it is difficult for the user to distinguish between them. That is, regarding the audio, there is a problem that it is desired to more flexibly utilize the content, such as listening to the explanation at the same time as the main audio or pre-confirming the audio of the seek destination before executing the seek.

Therefore, the audio reproduction device 100 according to the embodiment solves the above problem by audio reproduction processing described below. Specifically, when receiving a request for reproducing the sub-audio which is an audio signal different from the main audio from the user, the audio reproduction device 100 localizes the sub-audio signal to an arbitrary position in an acoustic space including an azimuth direction and a height direction, and outputs the main audio and the sub-audio in parallel. Note that the acoustic space is a three-dimensional virtual space centered on the user, and refers to a space in which a virtual audio source is arranged to reproduce a three-dimensional audio direction, distance, spread, and the like when reproduction an audio.

For example, the audio reproduction device 100 according to the embodiment gives a localization destination different from the main audio to the sub-audio in the acoustic space to facilitate listening to the main audio output at the same time. By performing the audio reproduction processing as described above, the audio reproduction device 100 enables simultaneous viewing of the main audio and the sub-audio in the same content. That is, the user can listen to each other's audio without confusing the main audio and the sub-audio.

An outline of the above processing will be described with reference to FIG. 1. Note that, in the example of FIG. 1, it is assumed that the user searches for a location different from the current reproduction position with the seek bar while reproducing the content and listens to the audio of the seek destination as the sub-audio.

Furthermore, in the example of FIG. 1, it is assumed that the content is content produced in an object-based spatial acoustic format, and is content having arrangement (coordinates) of each audio source on the acoustic space as metadata. In other words, the content illustrated in FIG. 1 is content in which a position in the acoustic space and an audio source to be localized are designated, and the user intentionally produces an audio to be heard from the designated position. Note that, hereinafter, the audio format having localization information as described above may be referred to as “spatial acoustic audio”.

FIG. 1 illustrates a user interface 10 when the user listens to the content. For example, the user interface 10 is displayed on a screen of the audio reproduction device 100. The user operates the user interface 10 with a pointing device such as a mouse, a finger, or the like to reproduce or stop the content, designate the seek destination, or the like.

An information display area 20 illustrated in FIG. 1 includes a seek bar 22 and the like for the user to designate the seek destination. Note that the seek bar 22 also includes a function as a progress bar indicating a current reproduction position 28 of the content.

Furthermore, the information display area 20 includes a time display 26 indicating the entire reproduction time and the current reproduction position of the content and a bar 24 indicating a reproduction status.

The user can specify a desired seek destination by hovering the pointing device over the seek bar 22. For example, a point 30 illustrated in FIG. 1 indicates that the user has placed the mouse over a seek destination 32.

When the point 30 is moused over the seek destination 32, the audio reproduction device 100 reproduces the audio of the seek destination as a sub-audio in parallel with the main audio. In the example of FIG. 1, the audio reproduction device 100 reproduces the main audio (that is, the future audio with respect to the current reproduction position of the content) having a reproduction position of “18:00” as the seek destination as a start point as the sub-audio. At this time, on the bar 24 indicating the reproduction status, a reproduction display 34 indicating that the sub-audio is to be reproduced is displayed as an animation at a location corresponding to the seek destination 32. As a result, the user can visually confirm that the sub-audio is being reproduced.

Next, the localization destination of the sub-audio will be described. As described above, in the example of FIG. 1, since the content is the content produced in the object-based spatial acoustic format, the arrangement information on the coordinates of each audio source is included as the metadata. A sound map 40 illustrated in FIG. 1 visually expresses arrangement information on the coordinates of each audio source. Note that the number in the sound map 40 indicates the type of audio source (for example, a musical instrument such as a vocal, a guitar, or a bass, or a performer or the like in the case of an audio drama). Furthermore, since the sound map 40 illustrated in FIG. 1 indicates all the localization destinations included in the content, in a case where the audio source moves with the progress of the content, the sound map also includes the movement destination and is displayed.

An upper sound map 42 indicates the audio source arranged at the upper position with the user as the center. A middle sound map 44 indicates an audio source arranged at a horizontal position with the user as the center. A lower sound map 46 indicates an audio source arranged at a lower position with the user as the center. As illustrated in FIG. 1, each audio source included in the sound map 40 is defined not only in the height direction but also in the distance to the user.

When acquiring the metadata indicated in the sound map 40, the audio reproduction device 100 analyzes the acquired information and determines the localization destination of the sub-audio based on the analyzed information. In the example of FIG. 1, the audio reproduction device 100 localizes the sub-audio to a position not overlapping with the main audio. Specifically, the audio reproduction device 100 analyzes the metadata and determines that the main audio is not arranged above and behind the user. Then, the audio reproduction device 100 localizes the sub-audio to an area 48 above and behind the user.

As described above, as an example, the audio reproduction device 100 can analyze the metadata and localize the sub-audio to a position that does not overlap with the main audio. As a result, the audio reproduction device 100 can make the user listen to the sub-audio reproduced from a position completely different from the main audio, and thus can make it easy to distinguish between the main audio and the sub-audio.

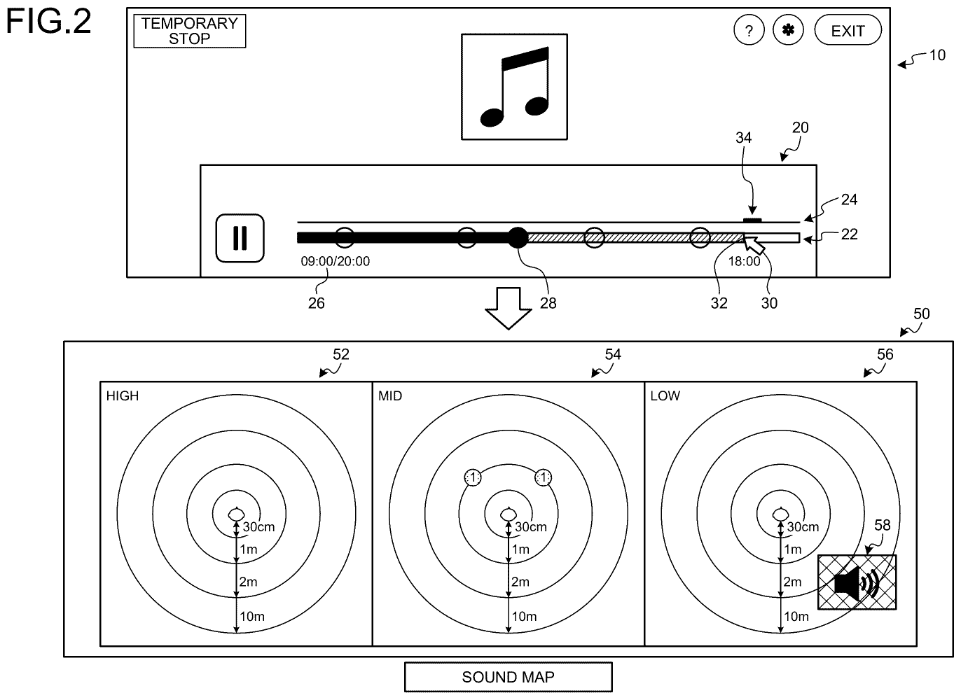

Next, another example of the audio reproduction processing according to the embodiment will be described with reference to FIG. 2. FIG. 2 is a diagram (2) illustrating an outline of the audio reproduction processing according to the embodiment.

In the example of FIG. 2, similarly to the example of FIG. 1, it is assumed that the user searches for a location different from the current reproduction position with the seek bar while reproducing the content and listens to the audio of the seek destination as the sub-audio. Note that, in the example of FIG. 2, it is assumed that the content is the content created by the conventional stereo audio divided into two channels, and is the content having no metadata such as the coordinate position of the audio source.

In this case, a sound map 50 of the content is expressed as in FIG. 2, for example. That is, no audio source is included in an upper sound map 52 and a lower sound map 56, and audio sources are arranged in the right front and the left front of the user in a middle sound map 54. Note that the sound map 50 illustrated in FIG. 2 merely conceptually expresses the stereo audio, and the user can listen to audios heard from other than the two front audio sources depending on the adjustment of a stereo pan in the recording.

In the example of FIG. 2, the audio reproduction device 100 localizes the sub-audio by a method different from that in FIG. 1. As an example, the audio reproduction device 100 localizes the sub-audio to a position linked with the user's vision. Specifically, the audio reproduction device 100 localizes the sub-audio so that the seek destination 32 to which the user has placed the mouse over the seek bar 22 corresponds to the position where the sub-audio is heard.

In the example illustrated in FIG. 2, the seek bar 22 is disposed below the user interface 10. The position of the seek destination 32 on the seek bar 22 is rightward with respect to the entire seek bar 22. The audio reproduction device 100 localizes the sub-audio to an area 58 illustrated in the lower sound map 56 based on these positional relationships. The area 58 is located below and behind the user. Therefore, since the user recognizes that the position on the user interface 10 at which the user has moused over the point 30 coincides with the location where the sub-audio is heard, it is easy to sense that the sub-audio has been reproduced, and confusion with the main audio is unlikely to occur. Further, the audio reproduction device 100 may move the area 58 each time the user moves the point 30. As a result, since the user can listen to the sub-audio linked with the location where the user is seeking, the user can easily intuitively recognize the sub-audio, and the accuracy of listening can be improved.

As described above, as an example, the audio reproduction device 100 can localize the sub-audio to a position linked with the user operation in the user interface 10. As a result, since the audio reproduction device 100 can make it easy for the user to recognize the reproduction start and the reproduction position of the sub-audio, it is possible to make it easy to distinguish the main audio and the sub-audio from each other and to provide a reproduction environment with high usability.

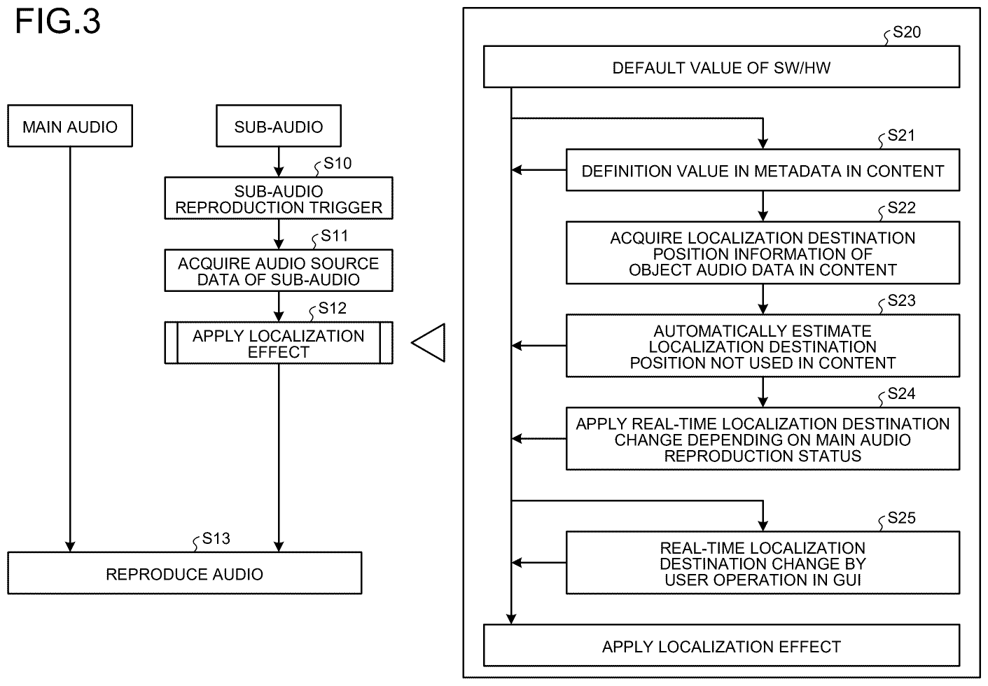

The outline of the audio reproduction processing according to the embodiment has been described above with reference to FIGS. 1 and 2. Note that the audio reproduction device 100 may localize the sub-audio by various methods in addition to the examples illustrated in FIGS. 1 and 2. In this regard, the localization processing of the sub-audio will be described with reference to FIG. 3. FIG. 3 is a flowchart illustrating an example of localization processing of the sub-audio according to the embodiment.

As illustrated in FIG. 3, the audio reproduction device 100 detects a trigger related to the sub-audio reproduction (Step S10). For example, the audio reproduction device 100 detects a trigger such as an operation for explaining content or reproduction a sub-audio such as another recording audio, or an operation on the seek bar.

When the sub-audio reproduction trigger is detected, the audio reproduction device 100 acquires the audio source data of the sub-audio (Step S11). For example, the audio reproduction device 100 acquires the sub-audio signal recorded in the content, or acquires (generates) the audio starting from the reproduction location of the seek destination in the main audio.

Subsequently, the audio reproduction device 100 determines a position at which the sub-audio is localized and applies a localization effect to the sub-audio (Step S12). Details of such processing will be described later. The audio reproduction device 100 reproduces the sub-audio to which the localization effect is applied simultaneously with the main audio (Step S13).

Details of the processing of Step S12 will be described. First, the audio reproduction device 100 determines whether to reproduce the sub-audio with a default value of software or hardware (Step S20). The default value of the software or hardware is a setting value used in a case where the audio reproduction processing in the subsequent stage is not applied, and is, for example, an initial setting set in advance in the reproduction device or the reproduction application, such as reproduction the sub-audio at the same position as the main audio or reproduction the main audio in an L channel and the sub-audio in a R channel. As an example, the audio reproduction device 100 may adopt a localization position in consideration of auditory characteristics as a default value. In other words, the audio reproduction device 100 may adopt, as the default value, a setting of localizing the sub-audio to a position (for example, proximate and aft) in the acoustic space which is hardly affected by the listening characteristic of the individual.

Subsequently, the audio reproduction device 100 determines whether or not metadata is included in the content, and acquires a definition value in the metadata in the content when the metadata is included (Step S21). The definition value in the in-content metadata is, for example, a setting value or the like indicating that the arrangement for reproducing the sub-audio in the content is determined in advance. When using such a definition value, the audio reproduction device 100 acquires the value and applies the localization effect.

In a case where the definition value is not used as it is or in a case where there is no definition value, the audio reproduction device 100 acquires localization destination position information of the object audio data in the content (Step S22). For example, the audio reproduction device 100 acquires the arrangement information of each audio source in the content such as the sound map 40 illustrated in FIG. 1.

Then, the audio reproduction device 100 automatically estimates a localization destination position that is not used in the content (Step S23). For example, the audio reproduction device 100 refers to the sound map 40 and extracts a location (area 48 in the example of FIG. 1) that does not overlap with the main audio. As an example, the audio reproduction device 100 automatically extracts a range separated from each audio source by a predetermined distance or more or a range in which the number of overlapping audio sources is equal to or less than a predetermined number in the acoustic space. In a case where the sub-audio is localized at the automatically estimated position, the audio reproduction device 100 acquires the value and applies the localization effect.

Note that the audio reproduction device 100 can also apply a position other than the automatically estimated position. For example, the audio reproduction device 100 may apply a real-time localization destination change depending on the main audio reproduction status (Step S24). As described above, in a case where the main audio is the spatial acoustic audio, the position where the audio source of the main audio is localized may change along the progress of the content. The audio reproduction device 100 may also change the sub-audio in real time according to the change. As an example, the audio reproduction device 100 may allocate the sub-audio to various coordinates while selecting coordinates that do not overlap with the main audio in real time as the content progresses. In a case where the sub-audio is localized at coordinates that change in real time, the audio reproduction device 100 appropriately acquires the value in accordance with the progress of the content and applies the localization effect.

Furthermore, the audio reproduction device 100 may apply a real-time localization destination change by a user operation in a graphical user interface (GUI) such as on the user interface 10 (Step S25). For example, as illustrated in FIG. 2, the audio reproduction device 100 may change the localization destination of the sub-audio according to the designated position on the seek bar 22. Furthermore, the audio reproduction device 100 may present a display such as the sound map 40 to the user as a GUI and cause the user himself/herself to designate a position to which the sub-audio is to be assigned.

As described above, the audio reproduction device 100 can adopt various methods as processing of applying the localization effect of the sub-audio. For example, the audio reproduction device 100 may hold the localization effect to be applied for each type of content as a preset value, or may adopt an application method of the localization effect desired by the user.

As described above, the audio reproduction device 100 can determine the localization destination of the sub-audio by various methods and apply the localization effect. As a result, the audio reproduction device 100 can determine the optimal localization destination in various situations such as the genre of the content and the operation of the user.

### 1-2. Configuration of Audio Reproduction Device According to Embodiment

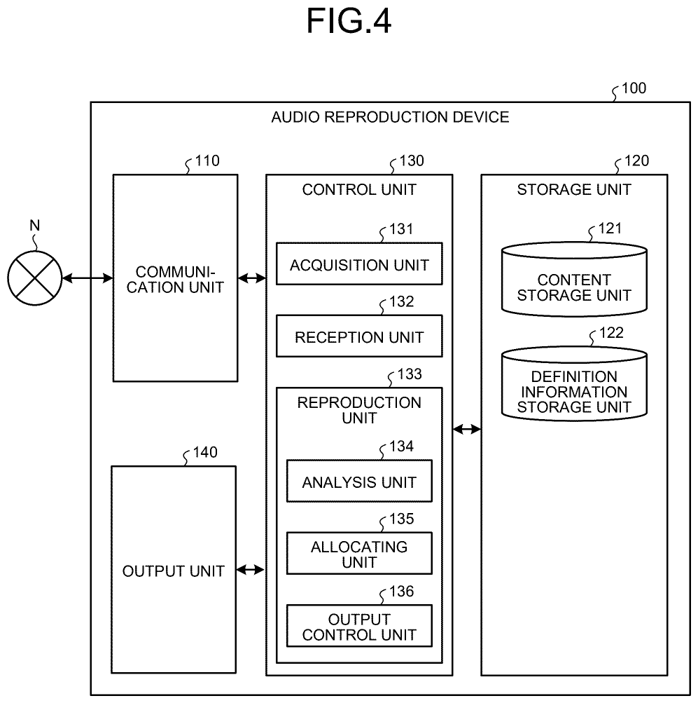

Next, a configuration of the audio reproduction device 100 according to the embodiment will be described with reference to FIG. 4. FIG. 4 is a diagram illustrating a configuration example of the audio reproduction device 100 according to the embodiment.

As illustrated in FIG. 4, the audio reproduction device 100 includes a communication unit 110, a storage unit 120, a control unit 130, and an output unit 140. Note that the audio reproduction device 100 may include an input unit (for example, a touch panel) that receives various operations from a user or the like who operates the audio reproduction device 100, and a display unit (for example, a liquid crystal display) for displaying various types of information.

The communication unit 110 is realized by, for example, a network interface card (NIC) or the like. The communication unit 110 is connected to a network N (Internet, near field communication (NFC), Bluetooth, and the like) in a wired or wireless manner, and transmits and receives information to and from a reproduction device or the like via the network N.

The storage unit 120 is realized by, for example, a semiconductor memory element such as a random access memory (RAM) or a flash memory, or a storage device such as a hard disk or an optical disk. As illustrated in FIG. 4, the storage unit 120 includes a content storage unit 121 and a definition information storage unit 122.

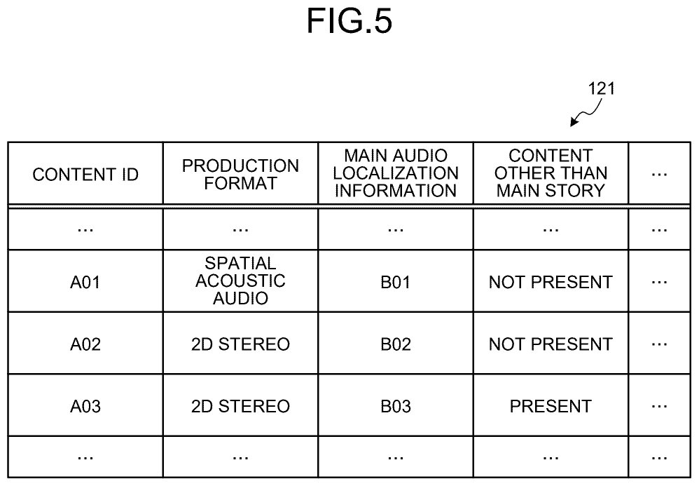

The content storage unit 121 stores content to be reproduced by the audio reproduction device 100. FIG. 5 illustrates an example of the content storage unit 121 according to the embodiment. FIG. 5 is a diagram illustrating an example of the content storage unit 121 according to the embodiment. In the example illustrated in FIG. 5, the content storage unit 121 includes items such as “content ID”, “production format”, “main audio localization information”, and “content other than the main story”.

The “content ID” indicates identification information for identifying content. The “production format” indicates a format (recording format) in which the content is produced. The “main audio localization information” is metadata of content, and indicates an audio source of the main audio, information regarding coordinates at which each audio source is localized, and the like. The “content other than the main story” indicates whether or not a sub-audio content, which is an audio (explanation of the content or the like) other than the main audio and has a different content from the main audio, is included. Note that, in FIG. 5, item data may be conceptually described as “A01” or “B01”, but in practice, specific data corresponding to each item is stored in the item data. The definition information storage unit 122

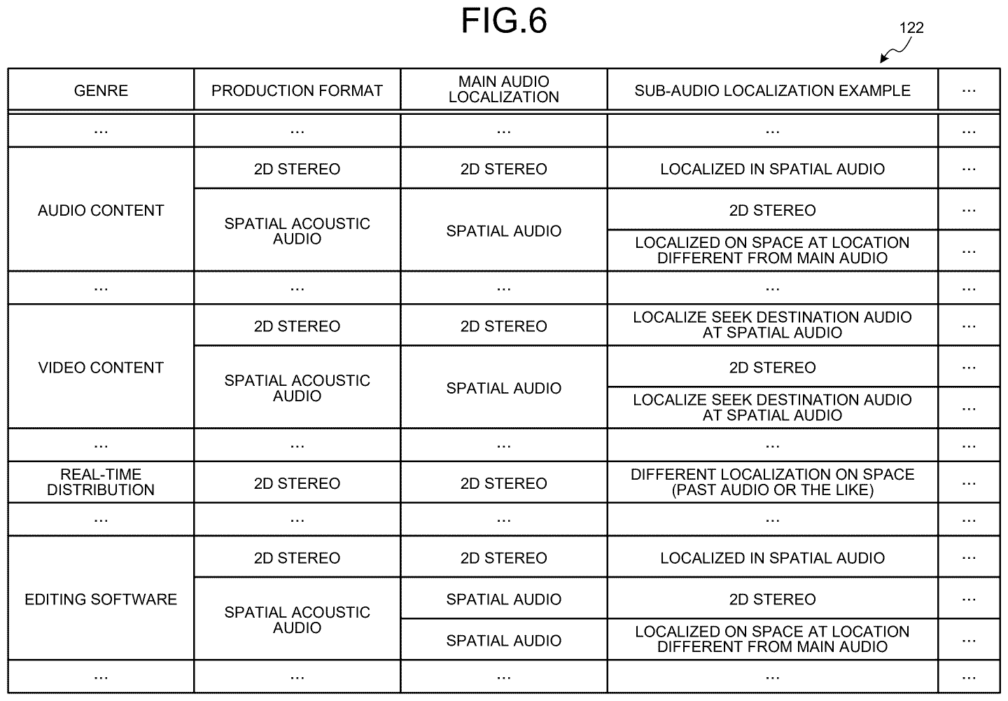

stores definition information defined when the audio reproduction device 100 localizes the sub-audio. FIG. 6 illustrates an example of the definition information storage unit 122 according to the embodiment. FIG. 6 is a diagram illustrating an example of the definition information storage unit 122 according to the embodiment. In the example illustrated in FIG. 6, the definition information storage unit 122 includes items such as “genre”, “production format”, “main audio localization”, and “sub-audio localization example”.

The “genre” indicates a genre defined in the content. The “production format” indicates a format in which the content is produced. The “main audio localization” indicates a localization format when the main audio is reproduced. The “sub-audio localization example” indicates an example of a method when the audio reproduction device 100 localizes the sub-audio.

For example, in the example illustrated in FIG. 6, when the genre is “audio content” and the production format is “2D stereo (music content in which stereo audio is recorded without coordinate information such as spatial acoustic audio)”, the audio reproduction device 100 defines that the main audio is localized to the “2D stereo”, and when the sub-audio is reproduced, the audio reproduction device defines that the audio is “localized in spatial audio”. For example, in a case where the audio reproduction device 100 receives a request to reproduce the sub-audio with the content, as illustrated in FIG. 2, the sub-audio is localized to the lower part and the rear part of the user, which is localization different from the main audio of the 2D stereo.

Alternatively, in another example illustrated in FIG. 6, when where the genre is “audio content” and the production format is the “spatial acoustic audio”, the audio reproduction device 100 defines that the main audio is localized on the “spatial audio”, and when the sub-audio is reproduced, the audio reproduction device defines that the audio is localized to “the 2D stereo” or “localized on a space at a location different from the main audio”. In this case, when the audio reproduction device 100 receives a request to reproduce the sub-audio with the content, the audio reproduction device allocates the sub-audio to the front two channels, unlike the main audio arranged on the acoustic space. This is because the spatial acoustic audio is often localized at various coordinates, and thus localization of the sub-audio to two channels ahead (localization positions of normal stereo audio) may be more differentiated. Alternatively, as illustrated in FIG. 1, the audio reproduction device 100 may localize the sub-audio in an arbitrary range on the acoustic space that does not overlap with the main audio.

Note that the definition information illustrated in FIG. 6 is merely an example, and the audio reproduction device 100 can perform various processes such as holding different definitions for each content or flexibly assigning localization of the sub-audio according to user's operation.

Returning to FIG. 4, the description will be continued. The control unit 130 is implemented by, for example, a central processing unit (CPU), a micro processing unit (MPU), or the like executing a program (for example, an audio reproduction program according to the present disclosure) stored inside the audio reproduction device 100 using a random access memory (RAM) or the like as a work area. Furthermore, the control unit 130 is a controller, and may be realized by, for example, an integrated circuit such as an application specific integrated circuit (ASIC) or a field programmable gate array (FPGA).

As illustrated in FIG. 4, the control unit 130 includes an acquisition unit 131, a reception unit 132, and a reproduction unit 133, and implements or executes a function and an action of information processing described below. Note that the internal configuration of the control unit 130 is not limited to the configuration illustrated in FIG. 4, and may be another configuration as long as information processing to be described later is performed.

The acquisition unit 131 acquires various types of information. For example, the acquisition unit 131 acquires content to be reproduced by the audio reproduction device 100 via the network N. When the content includes the metadata, the acquisition unit 131 acquires the metadata together with the content. Note that, in a case where the content is streaming distribution content or the like, the acquisition unit 131 continues processing of sequentially acquiring the content during reproduction.

The reception unit 132 receives, from the user, a request for reproducing a second audio signal (sub-audio) that is an audio signal different from a first audio signal (main audio) that is the original audio signal of the content.

Note that, in the present disclosure, the sub-audio includes any audio signal that is not an audio originally reproduced at the current reproduction position during reproduction of the content. For example, in a case where the main audio is an audio signal for outputting an audio that coincides with the current reproduction position of the content, the sub-audio may be an audio signal for outputting an audio that includes the same data as that of the main audio and does not coincide with the current reproduction position of the content. In this case, an example of the sub-audio is an audio (main audio signal having a different time axis) of a seek destination different from the current reproduction position. Alternatively, the sub-audio may be an audio signal including data different from the main audio. For example, the sub-audio is an explanation of the content, a bonus track, another audio recorded as an audio track different from the main audio, an audio in a language different from the main audio, or the like.

For example, the reception unit 132 receives, from the user, a request for reproducing the sub-audio with an operation of the user designating a reproduction position different from the current reproduction position of the content as a trigger.

More specifically, the reception unit 132 receives designation of the reproduction position as the user's operation based on an operation instruction based on a pointing device such as a mouse or a finger. For example, the reception unit 132 may receive a request for reproducing the sub-audio in response to a user operation on the seek bar indicating the reproduction position of the content displayed on the user interface of the music reproduction program.

Furthermore, the reception unit 132 may receive the designation of the reproduction position based on a line of sight, a posture, meshing, or a predetermined gesture of the user acquired from the image obtained by imaging the user. For example, in a case where the audio reproduction device 100 is a device including a camera such as a smartphone, the audio reproduction device 100 may image the user with an inward camera and receive the request based on a result of analyzing the captured image. For example, in a case where the line of sight of the user is directed forward (in the future) of the seek bar, the audio reproduction device 100 may determine that the user has requested reproduction of the seek destination audio, and may receive the reproduction request of the sub-audio starting from the seek destination. Furthermore, in a case where the user tilts the body to the left and right, or in a case where the audio reproduction device 100 tilts the audio reproduction device 100 itself to the left and right, the audio reproduction device may reflect information acquired by the camera or the acceleration sensor on the seek bar and receive the reproduction request of the sub-audio based on such information. Alternatively, the audio reproduction device 100 may analyze, from the camera image, that the user has applied a force to the right palate by meshing or that the user has applied a force to the left palate, reflect the analyzed information in the seek bar, and receive the reproduction request of the sub-audio based on the information. Moreover, in a case where a predetermined gesture operation (extending a hand in a right direction, sliding a finger, or the like;) is captured as a camera image, the audio reproduction device 100 may receive a predetermined request to reproduce, as the sub-audio, an audio that is ahead of the current reproduction position by a predetermined time. Note that the audio reproduction device 100 may receive settings of these gesture operations from the user in advance. Furthermore, the reception unit 132 may receive an audio operation from the user without being limited to the gesture operation. For example, in a case where the audio reproduction device 100 is a device including a microphone, the reception unit 132 can recognize an audio uttered by the user and perform an operation according to the recognized content. For example, in a case where the user utters the time of the reproduction portion by audio, the reception unit 132 receives designation of the reproduction position according to the audio.

Furthermore, the reception unit 132 may receive a request related to localization of the sub-audio from the user on the user interface indicating the acoustic space. For example, the reception unit 132 displays, as an interface, a display (for example, the sound map 40 and the like illustrated in FIG. 1) schematically illustrating an acoustic space centered on the user on the music reproduction application. When the user specifies desired coordinates in the acoustic space in the displayed interface, the reception unit 132 receives the position specified by the user as a request related to localization of the sub-audio. As a result, the user can freely map the sub-audio to the position on the spatial audio that the user wants to localize.

The reproduction unit 133 includes an analysis unit 134, an allocating unit 135, and an output control unit 136, and controls to reproduce audio included in content based on a function of each unit. For example, the analysis unit 134 analyzes audio data recorded in the content, metadata included in the content, and the like. The allocating unit 135 assigns the sub-audio to an arbitrary position in the acoustic space based on the information analyzed by the analysis unit 134. The output control unit 136 outputs the audio data to the output unit 140 so as to reproduce the sub-audio allocated by the allocating unit 135 and the main audio of the content in parallel.

That is, when the reception unit 132 receives the request for the sub-audio reproduction, the reproduction unit 133 localizes the sub-audio to an arbitrary position in the acoustic space including the azimuth direction and the height direction, and outputs the main audio and the sub-audio in parallel.

As described above, the reproduction unit 133 can localize the sub-audio to various positions on the acoustic space according to the genre of the content, the designation of the user, the listening characteristic of the human, and the like. As an example, in a case where the main audio includes a stereo audio signal localized in front of the user, the reproduction unit 133 localizes the sub-audio to the rear of the user. Alternatively, in a case where the main audio includes a signal (hereinafter, referred to as a “spatial audio signal”) based on the spatial acoustic audio format, the reproduction unit 133 localizes the sub-audio to a position that does not overlap with the position of the spatial audio signal that is the main audio.

Alternatively, the reproduction unit 133 may localize the sub-audio to a predetermined position regardless of the information of the main audio. As an example, the reproduction unit 133 may localize the sub-audio above and at the center of the user. Normally, since the user feels as if the audio falls down from the ceiling in the upper portion and the center, the audio is not actively used as the main audio. However, by localizing the sub-audio at the position, in a case where the announcement audio such as the explanation of the content is the sub-audio, the user can feel an audio that does not overlap with any other audio and is positioned in a different dimension, so that the listening property can be improved.

Furthermore, in a case where a request (designation of a position) regarding localization of the sub-audio is received from the user on the user interface indicating the acoustic space, the reproduction unit 133 may localize the sub-audio according to the received request of the user.

Furthermore, as illustrated in FIG. 1, in a case where the user operation on the seek bar indicating the reproduction position of the content is detected, the reproduction unit 133 may localize the sub-audio to a position in the acoustic space corresponding to the operation position of the user on the seek bar. Furthermore, the reproduction unit 133 may localize the sub-audio to an arbitrary position in the acoustic space based on the display position of the seek bar on the user interface of the music reproduction program and the operation position of the user of the seek bar in consideration of the position of the seek bar on the screen and the like. As a result, the user can listen to the audio while experiencing the seek bar on the screen or the localization of the sub-audio changing according to his/her seek operation, and thus, it is easy to pay attention to the sub-audio that is the audio of the seek destination, and the listening property can be improved.

Note that the reproduction unit 133 may reproduce the audio based on a mode of various operations of the user on the seek bar. For example, the reproduction unit 133 may start reproduction of the sub-audio when the user moves the mouse cursor to an arbitrary position of the seek bar as a trigger, and when the click is performed at the position, reproduce the main audio (that is, reproduce the main audio) from the continuation of the sub-audio reproduced as the seek destination audio. In this case, the user may select by setting whether the reproduction start location by clicking is from continuation of the seek destination audio or from the cursor position.

Furthermore, in a mode in which the user operates the touch panel using the finger, the reproduction unit 133 may reproduce the seek destination audio as the sub-audio while the user holds the finger in the seek bar on the touch panel, and may reproduce the main story from the continuation of the reproduced seek destination audio when the user releases the finger on the seek bar. In this case, in a case where the user drags the finger to a position not on the seek bar and then releases the finger, the user can cancel the seek operation. Furthermore, the user may select by setting whether the reproduction start location when the finger is released is from continuation of the seek destination audio or from the cursor position.

In addition, also in a case where the music reproduction application includes forward and rewind buttons of a fixed number of seconds such as skipping by 10 seconds, the reproduction unit 133 may reproduce the audio of the seek destination when the user mouse over or places a finger on the button.

Furthermore, in a case where the music reproduction application has a video display function, the reproduction unit 133 may display the seek destination video as a thumbnail together with the seek destination audio.

Further, the reproduction unit 133 may reproduce the sub-audio based on not only software control such as a music reproduction application but also hardware control. For example, in a case where a seek is performed by an operation of an operation button, a keyboard, an external jog dial, or the like attached to an earphone, the reproduction unit 133 may reproduce the seek destination audio at a point of time when the hand is held over the button, and in a case where the button is pressed, the reproduction unit may reproduce the main story from the continuation of the seek destination audio. Furthermore, the reproduction unit 133 may perform reproduction in various modes according to the user's setting or the like, such as omitting the button pressing action, automatically transitioning to the seek destination when the user releases the button, and reproduction the main story.

Furthermore, in a case where the sub-audio is localized at an arbitrary position, the reproduction unit 133 may perform predetermined filter processing on the main audio output in parallel. For example, by applying a low-pass filter to the main audio, the reproduction unit 133 can apply an effect of making the content of the main audio easy for the user to hear. In this regard, since it is important to make the user aware that “some change occurred in the main audio and the audio at the seek destination started to be reproduced at the same time” when the user performs a seek, the reproduction unit 133 may perform a predetermined effect such as changing the volume of the main audio or changing the tone color without being limited to the filter processing (audio quality processing).

The output unit 140 outputs the audio signal controlled by the reproduction unit 133 as an audio. For example, the output unit 140 is a loudspeaker built in the audio reproduction device 100. Note that the audio output may be performed by an external speaker, a headphone, or the like connected via the communication unit 110, instead of the output unit 140.

### 1-3. Procedure of Audio Reproduction Processing According to Embodiment

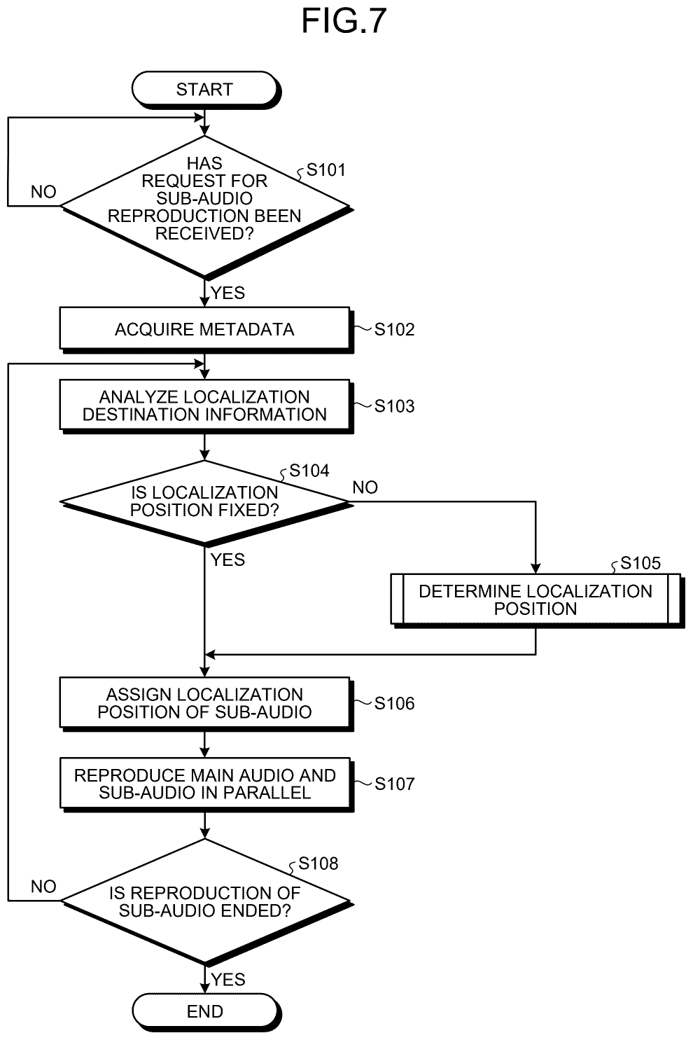

Next, a procedure of the audio reproduction processing according to the embodiment will be described with reference to FIG. 7. FIG. 7 is a flowchart illustrating the procedure of the audio reproduction processing according to the embodiment.

First, the audio reproduction device 100 determines whether or not a request for sub-audio reproduction has been received from the user (Step S101). When the request for the sub-audio reproduction has not been received (Step S101; No), the audio reproduction device 100 does not reproduce the sub-audio but continues reproduction only the main audio.

Meanwhile, in a case where the request for the sub-audio reproduction has been received (Step S101; Yes), the audio reproduction device 100 acquires the metadata included in the content (Step S102). The audio reproduction device 100 analyzes the localization destination information based on the acquired metadata (Step S103). For example, the audio reproduction device 100 analyzes information regarding the main audio arranged in the spatial audio, and acquires information such as a non-overlapping range in a case where the sub-audio is reproduced. Note that, in a case where the content does not include the metadata related to the spatial audio, the audio reproduction device 100 appropriately acquires, as the metadata, information contributing to determination of the localization destination in the subsequent stage, such as that the content is in a file format including only the stereo audio.

Subsequently, the audio reproduction device 100 determines whether or not to localize the sub-audio to a fixed position (Step S104). For example, the audio reproduction device 100 determines whether there are arbitrary coordinates designated by the user as the localization destination of the sub-audio, or whether there is information or the like that has been set in advance to localize the sub-audio in the range of the lower rear portion of the user according to the audibility characteristic.

In a case where the localization destination of the sub-audio is not fixed (Step S104; No), the audio reproduction device 100 determines the localization position of the sub-audio in real time according to the progress of the content (Step S105). For example, according to the processing procedure illustrated in FIG. 3, the audio reproduction device 100 determines the localization position of the sub-audio at a position not overlapping with the main audio or a position (for example, a position in the acoustic space corresponding to the position instructed by the seek bar) linked to the reproduction location designated by the user.

In a case where the localization position is fixed (Step S104; Yes), or in a case where the localization position is determined in real time (Step S105), the audio reproduction device 100 assigns the localization position of the sub-audio (Step S106).

Then, the audio reproduction device 100 reproduces the main audio and the sub-audio simultaneously in parallel (Step S107). At this time, audio reproduction device 100 may perform processing of applying filter processing to the main audio or the sub-audio or adjusting the volume.

Thereafter, the audio reproduction device 100 determines whether or not an operation for ending reproduction of the sub-audio has been received from the user (Step S108). When the reproduction of the sub-audio is not ended (Step S108; No), the audio reproduction device 100 returns to the processing of Step S103, and appropriately determines the localization position of the sub-audio according to the progress of the content. In a case where the reproduction of the sub-audio is ended (Step S108; Yes), the audio reproduction device 100 ends the audio reproduction processing according to the embodiment.

### 1-4. Modification According to Embodiment

The information processing according to the embodiment described above may be accompanied by various modifications. Hereinafter, modifications of the embodiment will be described.

### 1-4-1. Application Example of Audio Reproduction Processing

In the above embodiment, an example has been described in which the audio reproduction processing according to the embodiment is mainly applied to content such as music. However, the audio reproduction processing according to the embodiment may be applied to content of various genres or forms.

For example, the content is not limited to recorded music content, and may be live radio (recitation, audio drama, language learning broadcast, and the like) or streaming distribution. For example, the audio reproduction processing according to the embodiment may be applied in a case where the user desires to reproduce slightly previous audio that the user has missed during broadcasting in the content.

Furthermore, the audio reproduction processing according to the embodiment may be incorporated in music or video editing software. For example, the user who uses the editing software can use the audio reproduction processing according to the embodiment in order to quickly check the audio at the time of the position slightly before or after the content being edited.

Furthermore, the audio reproduction processing according to the embodiment may be used in an online meeting, a webina, or the like held in real time. The user who views these contents can use the audio reproduction processing according to the embodiment in order to review and confirm the contents of the immediately preceding meeting, for example, in a case where the participation is late.

Furthermore, the content may be distribution content (such as gaming commentary) for explaining or explaining existing media content. In this case, the user may use the audio reproduction processing according to the embodiment, set the main audio as the audio of the game media, and set the sub-audio as the commentary or the commentary audio, and view the audio. As a result, the user can experience distribution that is easy to hear without confusing the game media with the commentary audio.

Furthermore, the user may use the audio reproduction processing according to the embodiment for the game play. In this case, the user may play the game by setting the main audio to the audio of the game media and setting the sub-audio to the audio chat audio. As a result, since the user can recognize the game media and the audio of the audio chat separately on the acoustic space, the user can be immersed in the game play without being disturbed by each other's audio.

Furthermore, in a case where the user listens to the music medium and the external audio at the same time, the user may use the audio reproduction processing according to the embodiment. For example, when the user is a DJ (disc jockey) player or an engineer in charge of a stage monitor, it is necessary to simultaneously check a music medium being played and an audio (air monitor) actually played on the floor. In such a case, the user generally takes a style of wearing headphones on one ear and listening to an air monitor on one ear. According to the audio reproduction processing according to the embodiment, even when the headphones are worn on both ears, the user can separately listen to the music medium being reproduced and the air monitor, and thus can continue the play without any trouble.

### 1-4-2. Content Format Type

The audio reproduction processing according to the embodiment can be applied regardless of the format type of the content.

For example, the spatial acoustic format may be any format such as the above-described object-based format (for example, “360 Reality Audio (registered trademark)” or the like), a channel-based format assumed to be reproduced in multiple channels, or a scene-based format corresponding to viewpoint movement or the like by allocating an audio source to a space. Furthermore, in a case where the production format is spatial acoustic audio and the audio is reproduced in two channels, audio recorded in the spatial audio is appropriately downmixed and reproduced, but the audio reproduction processing according to the embodiment may be incorporated at that stage. Furthermore, in a case where the production

format is stereo audio and there are a plurality of output sources (multichannel speakers and the like) in the reproduction environment, there is an up-conversion technology for distributing the audio to multiple channels, but the audio reproduction processing according to the embodiment may be incorporated at that stage.

### 1-4-3. Mode of Sub-Audio

In the embodiment, explanation recorded separately from the main audio, an audio reproduced on a time axis different from the main audio, and the like are exemplified as the sub-audio. However, the sub-audio according to the present disclosure is a generic name of an audio localized at a position different from the main audio, and is not limited to the one described in the embodiment.

For example, the sub-audio may be an audio obtained by applying filter processing to the main audio and extracting only a certain musical instrument. For example, in a case where the user desires to listen to only the audio of one musical instrument of the music, the user may perform filter processing of extracting the musical instrument, set the extracted audio as the sub-audio, and listen to the audio with a localization different from the main audio.

### 2. Other Embodiments

The processing according to each embodiment described above may be performed in various different modes other than each embodiment described above.

Among the processes described in the above embodiments, all or part of the processes described as being performed automatically can be performed manually, or all or part of the processes described as being performed manually can be performed automatically by a known method. In addition, the processing procedure, specific name, and information including various data and parameters illustrated in the document and the drawings can be arbitrarily changed unless otherwise specified. For example, the various types of information illustrated in each figure are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, the above-described embodiments and modifications can be appropriately combined within a range in which the processing contents do not contradict each other.

Furthermore, the effects described in the present specification are merely examples and are not limited, and other effects may be provided.

### 3. Effects of Audio Reproduction Device According to Present Disclosure

As described above, the audio reproduction device (the audio reproduction device 100 in the embodiment) according to the present disclosure includes the reception unit (the reception unit 132 in the embodiment) and the reproduction unit (the reproduction unit 133 in the embodiment). The reception unit receives, from the user, a request for reproducing a second audio signal (sub-audio in the embodiment) that is an audio signal different from a first audio signal (main audio in the embodiment) that is an original audio signal of the content. When the reception unit receives the request, the reproduction unit localizes the second audio signal to an arbitrary position in the acoustic space including the azimuth direction and the height direction, and outputs the first audio signal and the second audio signal in parallel.

As described above, the audio reproduction device according to the present disclosure provides the second audio signal with a localization destination different from that of the first audio signal in the acoustic space, thereby facilitating listening to the first audio signal output at the same time. As a result, the audio reproduction device can be used in various ways such that the user quickly checks the audio signal recorded in the content or listens to different audios at the same time, and thus the convenience of the content can be improved.

In addition, the first audio signal is an audio signal that outputs an audio that coincides with the current reproduction position of the content, and the second audio signal is an audio signal that includes the same data as the first audio signal and outputs an audio that does not coincide with the current reproduction position of the content. The reproduction unit outputs the first audio signal and the second audio signal in parallel.

As described above, the audio reproduction device can respond to the user's need to simultaneously listen to the audio of another portion while listening to the main audio by reproducing two audios having different time axes at different localization destinations.

In addition, the reception unit receives, from the user, a request for reproducing the second audio signal in response to an operation of the user designating the reproduction position different from the current reproduction position of the content.

As described above, the audio reproduction device can provide the user with an experience excellent in operability and convenience by receiving the reproduction of the second audio signal triggered by the user's search operation.

Furthermore, the reception unit receives, as the user's operation, an operation instruction based on a pointing device, or position designation based on the user's line of sight, posture, meshing, or predetermined gesture acquired from an image obtained by imaging the user.

As described above, the audio reproduction device can receive the request for reproducing the second audio signal according to the operation of various modes of the user, so that the usability can be improved.

In addition, the reception unit receives a request for reproducing the second audio signal in response to a user operation on the seek bar indicating the reproduction position of the content displayed on the user interface of the music reproduction program.

As described above, since the audio reproduction device receives the request for reproducing the second audio signal in response to the operation on the seek bar, it is possible to provide the user with an intuitively easy experience.

Furthermore, in a case where the first audio signal includes a stereo audio signal localized in front of the user, the reproduction unit localizes the second audio signal to the rear of the user.

As described above, the audio reproduction device can cause the user to listen to the sub-audio which is less likely to be confused and which is easy to distinguish, by providing the user with the sub-audio positioned behind, unlike the main audio.

Furthermore, in a case where the first audio signal includes a spatial audio signal, the reproduction unit localizes the second audio signal to a position that does not overlap with the position of the spatial audio signal in the acoustic space.

As described above, by making the localization destination in the space different from the main audio, the audio reproduction device can make the user listen to the sub-audio which is less likely to be confused and easy to distinguish.

Furthermore, the reproduction unit localizes the second audio signal above and at the center of the user. As described above, the audio reproduction device can provide the user with an easy-to-understand audio and a fresh experience by providing the user with an audio that is likely to fall down from a ceiling that is not normally used.

Furthermore, the reception unit receives a request related to localization of the second audio signal from the user on the user interface indicating the acoustic space. The reproduction unit localizes the second audio signal according to the request of the user received on the user interface.

In this manner, the audio reproduction device can reproduce the sub-audio at the designated position of the user, thereby performing reproduction according to the user's desire.

Furthermore, the reproduction unit localizes the second audio signal to a position in the acoustic space corresponding to the operation position of the user on the seek bar.

As described above, the audio reproduction device can provide the user with a listening experience that is intuitively easy to understand by localizing the sub-audio at the position linked with the seek bar.

Furthermore, the reproduction unit localizes the second audio signal to an arbitrary position in the acoustic space based on the display position of the seek bar on the user interface of the music reproduction program and the operation position of the user of the seek bar.

As described above, the audio reproduction device localizes the sub-audio in conjunction with the position of the seek bar on the screen, so that the user can intuitively recognize where the localized audio is the sub-audio.

In addition, the first audio signal is an audio signal that outputs audio matched with the current reproduction position of the content, and the second audio signal is an audio signal including data different from the first audio signal. The reproduction unit outputs the first audio signal and the second audio signal in parallel.

As described above, the audio reproduction device may localize an audio different from the main audio at a different position as the sub-audio. As a result, the audio reproduction device can provide the user with an easy-to-hear content experience in which the audio and explanation of the main content, the commentary of the distribution moving image, the media audio, and the like are separated.

Furthermore, in a case where the second audio signal is localized at an arbitrary position, the reproduction unit performs predetermined filter processing on the first audio signal output in parallel.

As described above, the audio reproduction device can make it easier for the user to hear the main audio and the sub-audio by performing the filter processing on the main audio.

### 4. Hardware Configuration

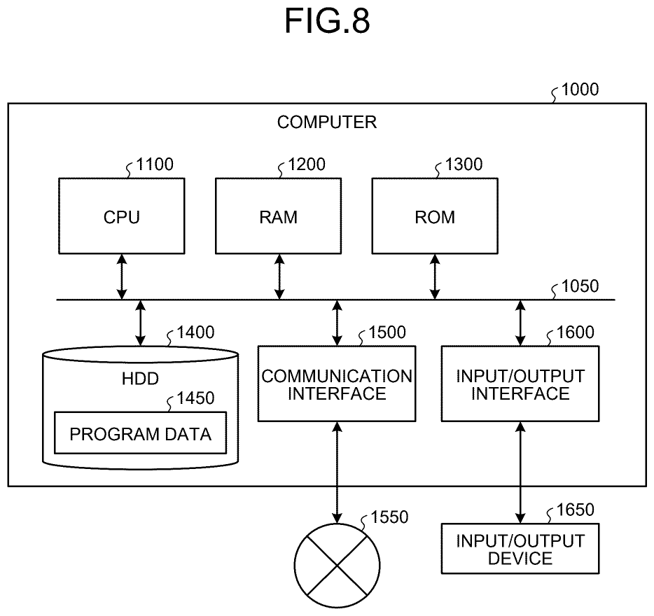

The information device such as the audio reproduction device 100 according to each embodiment described above is realized by, for example, a computer 1000 having a configuration as illustrated in FIG. 8. Hereinafter, the audio reproduction device 100 according to the embodiment will be described as an example. FIG. 8 is a hardware configuration diagram illustrating an example of a computer 1000 that implements the functions of the audio reproduction device 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400, and controls each unit. For example, the CPU1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an audio reproduction program according to the present disclosure as an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting a input/output device 1650 and the computer 1000. For example, the CPU1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the audio reproduction device 100 according to the embodiment, the CPU 1100 of the computer 1000 implements the functions of the control unit 130 and the like by executing the audio reproduction program loaded on the RAM 1200. In addition, the HDD 1400 stores an audio reproduction program according to the present disclosure and data in the storage unit 120. Note that the CPU 1100 reads the program data 1450 from the HDD 1400 and executes the program data, but as another example, these programs may be acquired from another device via the external network 1550.

Note that the present technology can also have the following configurations.
(1) An audio reproduction device comprising:
   a reception unit that receives, from a user, a request for reproducing a second audio signal that is an audio signal different from a first audio signal that is an original audio signal of content; and
   a reproduction unit that localizes the second audio signal at an arbitrary position in an acoustic space including an azimuth direction and a height direction and outputs the first audio signal and the second audio signal in parallel when the reception unit receives the request.
(2) The audio reproduction device according to (1), wherein
   the first audio signal is an audio signal that outputs an audio coincident with a current reproduction position of the content,
   the second audio signal is an audio signal that includes the same data as that of the first audio signal and outputs an audio not coincident with the current reproduction position of the content, and
   the reproduction unit outputs the first audio signal and the second audio signal in parallel.
(3) The audio reproduction device according to (2), wherein
   the reception unit receives, from the user, a request for reproducing the second audio signal in response to an operation of the user designating a reproduction position different from the current reproduction position of the content.
(4) The audio reproduction device according to (3), wherein
   the reception unit receives, as the operation of the user, an operation instruction based on a pointing device, or position designation based on a line of sight, a posture, meshing, or a predetermined gesture of the user acquired from an image obtained by imaging the user.
(5) The audio reproduction device according to (3) or (4), wherein
   the reception unit receives a request for reproducing the second audio signal in response to a user operation on a seek bar that is displayed on a user interface of a music reproduction program and indicates the reproduction position of the content.
(6) The audio reproduction device according to any one of (3) to (5), wherein
   the reproduction unit localizes the second audio signal behind the user in a case where the first audio signal includes a stereo audio signal localized in front of the user.
(7) The audio reproduction device according to any one of (3) to (5), wherein
   the reproduction unit localizes the second audio signal to a position that does not overlap with a position of a spatial audio signal in the acoustic space in a case where the first audio signal includes the spatial audio signal.
(8) The audio reproduction device according to any one of (3) to (7), wherein
   the reproduction unit localizes the second audio signal above and at the center of the user.
(9) The audio reproduction device according to any one of (3) to (8), wherein
   the reception unit receives a request related to localization of the second audio signal from the user on a user interface indicating the acoustic space, and
   the reproduction unit localizes the second audio signal according to the request of the user received on the user interface.
(10) The audio reproduction device according to (5), wherein
   the reproduction unit localizes the second audio signal to a position in the acoustic space corresponding to an operation position of a user on the seek bar.
(11) The audio reproduction device according to (10), wherein
   the reproduction unit localizes the second audio signal to an arbitrary position in the acoustic space based on a display position of the seek bar on the user interface of the music reproduction program and an operation position of the user of the seek bar.
(12) The audio reproduction device according to (1), wherein
   the first audio signal is an audio signal that outputs an audio coincident with the current reproduction position of the content,
   the second audio signal is an audio signal including data different from the first audio signal, and
   the reproduction unit outputs the first audio signal and the second audio signal in parallel.
(13) The audio reproduction device according to (12), wherein
   the reproduction unit localizes the second audio signal behind the user in a case where the first audio signal includes a stereo audio signal localized in front of the user.
(14) The audio reproduction device according to (12) or (13), wherein
   the reproduction unit localizes the second audio signal to a position that does not overlap with a position of the spatial audio signal in the acoustic space in a case where the first audio signal includes the spatial audio signal.
(15) The audio reproduction device according to any one of (12) to (14), wherein
   the reproduction unit localizes the second audio signal above and at the center of the user.
(16) The audio reproduction device according to any one of (12) to (15), wherein
   the reception unit receives a request related to localization of the second audio signal from the user on a user interface indicating an acoustic space, and
   the reproduction unit localizes the second audio signal according to the request of the user received on the user interface.
(17) The audio reproduction device according to any one of (1) to (16), wherein
   the reproduction unit performs predetermined filter processing on the first audio signal output in parallel in a case where the second audio signal is localized at an arbitrary position.
(18) An audio reproduction method comprising, by a computer:
   receiving, from a user, a request for reproducing a second audio signal that is an audio signal different from a first audio signal that is an original audio signal of content; and
   localizing the second audio signal at an arbitrary position in an acoustic space including an azimuth direction and a height direction and outputting the first audio signal and the second audio signal in parallel when receiving the request.
(19) An audio reproduction program that causes a computer to function as:
   a reception unit that receives, from a user, a request for reproducing a second audio signal that is an audio signal different from a first audio signal that is an original audio signal of content; and
   a reproduction unit that localizes the second audio signal at an arbitrary position in an acoustic space including an azimuth direction and a height direction and outputs the first audio signal and the second audio signal in parallel when the reception unit receives the request.

### REFERENCE SIGNS LIST

10 USER INTERFACE
100 AUDIO REPRODUCTION DEVICE
110 COMMUNICATION UNIT
120 STORAGE UNIT
121 CONTENT STORAGE UNIT
122 DEFINITION INFORMATION STORAGE UNIT
130 CONTROL UNIT
131 ACQUISITION UNIT
132 RECEPTION UNIT
133 REPRODUCTION UNIT
134 ANALYSIS UNIT
135 ALLOCATING UNIT
136 OUTPUT CONTROL UNIT
140 OUTPUT UNIT

1. An audio reproduction device comprising:
a reception unit that receives, from a user, a request for reproducing a second audio signal that is an audio signal different from a first audio signal that is an original audio signal of content; and
a reproduction unit that localizes the second audio signal at an arbitrary position in an acoustic space including an azimuth direction and a height direction and outputs the first audio signal and the second audio signal in parallel when the reception unit receives the request.

2. The audio reproduction device according to claim 1, wherein
the first audio signal is an audio signal that outputs an audio coincident with a current reproduction position of the content,
the second audio signal is an audio signal that includes the same data as that of the first audio signal and outputs an audio not coincident with the current reproduction position of the content, and
the reproduction unit outputs the first audio signal and the second audio signal in parallel.

3. The audio reproduction device according to claim 2, wherein
the reception unit receives, from the user, a request for reproducing the second audio signal in response to an operation of the user designating a reproduction position different from the current reproduction position of the content.

4. The audio reproduction device according to claim 3, wherein
the reception unit receives, as the operation of the user, an operation instruction based on a pointing device, or position designation based on a line of sight, a posture, meshing, or a predetermined gesture of the user acquired from an image obtained by imaging the user.

5. The audio reproduction device according to claim 3, wherein
the reception unit receives a request for reproducing the second audio signal in response to a user operation on a seek bar that is displayed on a user interface of a music reproduction program and indicates the reproduction position of the content.

6. The audio reproduction device according to claim 3, wherein
the reproduction unit localizes the second audio signal behind the user in a case where the first audio signal includes a stereo audio signal localized in front of the user.

7. The audio reproduction device according to claim 3, wherein
the reproduction unit localizes the second audio signal to a position that does not overlap with a position of a spatial audio signal in the acoustic space in a case where the first audio signal includes the spatial audio signal.

8. The audio reproduction device according to claim 3, wherein
the reproduction unit localizes the second audio signal above and at the center of the user.

9. The audio reproduction device according to claim 3, wherein
the reception unit receives a request related to localization of the second audio signal from the user on a user interface indicating the acoustic space, and
the reproduction unit localizes the second audio signal according to the request of the user received on the user interface.

10. The audio reproduction device according to claim 5, wherein
the reproduction unit localizes the second audio signal to a position in the acoustic space corresponding to an operation position of a user on the seek bar.

11. The audio reproduction device according to claim 10, wherein
the reproduction unit localizes the second audio signal to an arbitrary position in the acoustic space based on a display position of the seek bar on the user interface of the music reproduction program and an operation position of the user of the seek bar.

12. The audio reproduction device according to claim 1, wherein
the first audio signal is an audio signal that outputs an audio coincident with the current reproduction position of the content,
the second audio signal is an audio signal including data different from the first audio signal, and
the reproduction unit outputs the first audio signal and the second audio signal in parallel.

13. The audio reproduction device according to claim 12, wherein
the reproduction unit localizes the second audio signal behind the user in a case where the first audio signal includes a stereo audio signal localized in front of the user.

14. The audio reproduction device according to claim 12, wherein
the reproduction unit localizes the second audio signal to a position that does not overlap with a position of the spatial audio signal in the acoustic space in a case where the first audio signal includes the spatial audio signal.

15. The audio reproduction device according to claim 12, wherein
the reproduction unit localizes the second audio signal above and at the center of the user.

16. The audio reproduction device according to claim 12, wherein
the reception unit receives a request related to localization of the second audio signal from the user on a user interface indicating an acoustic space, and
the reproduction unit localizes the second audio signal according to the request of the user received on the user interface.

17. The audio reproduction device according to claim 1, wherein
the reproduction unit performs predetermined filter processing on the first audio signal output in parallel in a case where the second audio signal is localized at an arbitrary position.

18. An audio reproduction method comprising, by a computer:
receiving, from a user, a request for reproducing a second audio signal that is an audio signal different from a first audio signal that is an original audio signal of content; and
localizing the second audio signal at an arbitrary position in an acoustic space including an azimuth direction and a height direction and outputting the first audio signal and the second audio signal in parallel when receiving the request.

19. An audio reproduction program that causes a computer to function as:
a reception unit that receives, from a user, a request for reproducing a second audio signal that is an audio signal different from a first audio signal that is an original audio signal of content; and
a reproduction unit that localizes the second audio signal at an arbitrary position in an acoustic space including an azimuth direction and a height direction and outputs the first audio signal and the second audio signal in parallel when the reception unit receives the request.
